(19) United States
(12) Patent Application Publication
(10) Pub. No.: US 2006/0061586 A1
(43) Pub. Date: Mar. 23, 2006

(54) Display for visually impaired users

(76) Inventors: Christian Brulle-Drews, Hamburg (DE); Barbara Metternich, Filderslodt (DE)

Correspondence Address: THE ECLIPSE GROUP, 10605 BALBOA BLVD., SUITE 300, GRANADA HILLS, CA, 91344, US

(21) Appl. No.: 11/209,194

(22) Filed: Aug. 22, 2005

Related U.S. Application Data
(63) Continuation-in-part of application No. PCT/EP03/01822, filed on Feb. 21, 2003.

(51) Int. Cl. G09G 5/02

(52) U.S. Cl. 345/594

(57) ABSTRACT

A color display system is provided that may be suitable for use in a navigation system. The color display system includes a controller that selects a color scheme for the images and/or text displayed by a color display device in response to an indication of the user's ability to distinguish colors. The color display system further includes a user interface arranged to exchange information with the user, which may include color vision deficiency information indicating the user's ability to distinguish colors. Using the information regarding the user's ability to distinguish colors, the color display system may be configured to modify at least one parameter of the display's color scheme in response to a user's color vision deficiency information.

### PRIORITY CLAIM

1. Cross Reference to Related Applications

This application is a continuation-in-part of and claims priority to PCT Application No. PCT/EP2003/001822 filed Feb. 21, 2003, titled “METHOD FOR OBTAINING A COLOUR PALETTE IN A DISPLAY TO COMPENSATE FOR COLOUR BLINDNESS”, which is incorporated by reference into this application in its entirety.

### BACKGROUND OF THE INVENTION

1. Field of the Invention

The invention relates to color display devices for navigation systems.

2. Related Art

Color display devices for navigation systems present certain difficulties for users having color vision deficiencies, particularly where different displayed colors are utilized by such devices to provide information to users. As an example, modem vehicles often include color graphical user interface devices (“GUIs”) to provide information to the driver and passengers within a vehicle. Such color display devices, and the colors selected to be displayed by such devices, are often designed for compatibility with, and correspondence to, the character and styling of the vehicle. The colors utilized by the color display device may be selected, as an example, to correspond to the interior colors of a vehicle, or generally to provide an aesthetically attractive appearance.

As an example, a navigation system in a vehicle may use one color to display roads on a map, and then a separate color to highlight the route that a driver is directed to follow to reach a chosen destination. Alternatively, colors may be utilized to provide information on the status of the vehicle itself. As examples, information on tire pressure or engine temperature may be provided. An inability to read such information provided on color display devices may be problematic for a user and in the worst case may lead to dangerous situations when the user may be unable to read or interpret the information provided to him.

Although by law, vehicle drivers often must demonstrate a minimum overall level of visual sight capability, they may not be required to pass any tests that identify specific visual disabilities. As an example, drivers may not be required to pass a test regarding color vision deficiencies. Color blindness, and other color vision deficiencies, are common impairments affecting approximately 10% of the population. For these people, differentiating colors, as an example, may be difficult or even impossible. For example, a user having a red/green color vision deficiency may not be able to differentiate between the red indication of the road they are supposed to take and the green indication of the other major roads in the area.

The color combinations used in color display devices are generally predetermined such that they are comfortable and easy for users to view. In a vehicle navigation system, certain roads or geological features such as rivers or lakes may be allocated certain colors during the design and development stage of the system so that the displayed information may generally be easily understandable. Current color display systems may also allow users to select and adjust parameters of such a color display device. As an example, navigation systems for vehicles may allow the user to select between a “day” and a “night” display mode, where the brightness of the color display device may be reduced in the latter mode during darkness to make the color display device more comfortable to view at night. There is, however, a continuing need for a color display system that addresses the needs of users with color vision deficiencies.

### SUMMARY

A color display system is provided that may be suitable for use in a navigation system. The color display system includes a controller that selects a color scheme for the images and/or text displayed by a color display device in response to an indication of the user's ability to distinguish colors. The color display system further includes a user interface arranged to exchange information with the user, which may include color vision deficiency information indicating the user's ability to distinguish colors. Using the information regarding the user's ability to distinguish colors, the color display system may be configured to modify at least one parameter of the display's color scheme in response to a user's color vision deficiency information.

In one example embodiment, color vision deficiency information, may include a user color vision profile, user preferred color scheme, or particulars regarding a user color vision deficiency. This color vision deficiency information may be stored by or for the navigation system and recalled for future use.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 shows an example of an implementation of a color display system.

FIG. 2 shows a flow chart of an example of an implementation of a process for automatically controlling at least one parameter of a color scheme for a color display device in a color display system.

### DETAILED DESCRIPTION

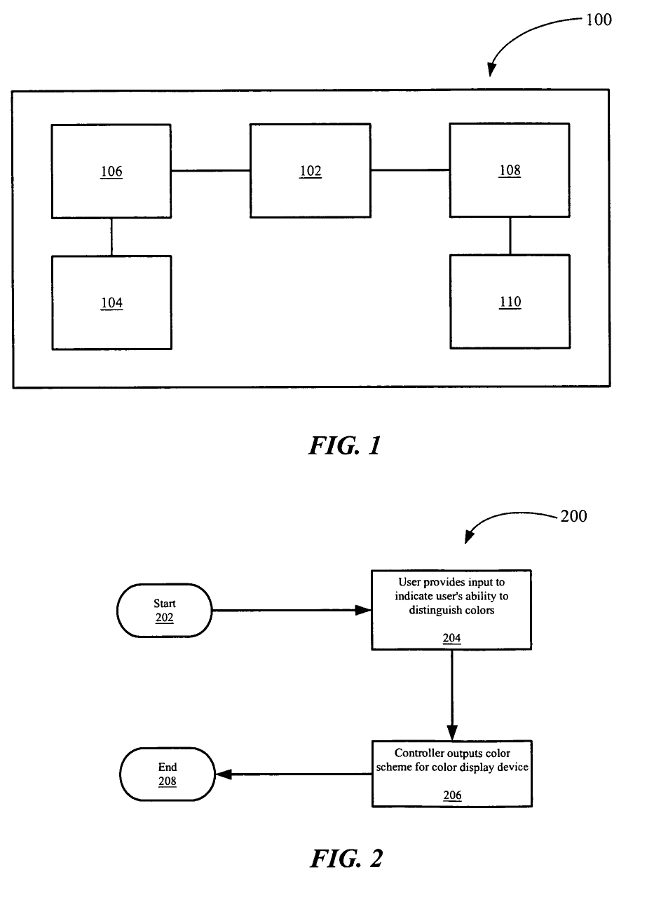

FIG. 1 shows an example of an implementation of a color display system 100. The color display system 100 may include a color display device 102, a user interface 104, and a controller 106. The color display device 102 may be arranged to display visual information to a user.

In one example of one implementation, a known parameter of a color scheme for the color display device 102 may be adjusted so that colors that cannot be distinguished by the user are replaced on the color display device 102 with colors that the user is able to distinguish. In another example, a parameter of a color scheme may be adjusted so that colors that cannot be distinguished by the user are arranged on the color display device 102 so as to be separated in the visual information by at least one other color that may be distinguished by the user. The color display device 102 may be any suitable device. As an example, the device may be a liquid crystal (LCD), electroluminescent (EL) or thin film transistor (TFT) display capable of either displaying full color or a plurality of colors.

In one example of one implementation, the color display system 100 utilizes color vision deficiency information regarding a user of the color display system 100 to adjust a color scheme for the color display device 102. Indications of a user's color vision deficiency information may include but are not limited to, a color vision deficiency type or status, color vision deficiency data, a color vision profile, or a color scheme. As examples, a color vision deficiency type or status may be indicated as normal, completely color-blind, or bichromatic color blindness. Color vision deficiency data may include details as to the colors that a user has difficulty distinguishing between. A color vision profile may include information as to an array of colors that a user can distinguish between. Results of a color vision test administered to a user can also be utilized. Conversion of such a type, data, profile, or test results into a form that can be used to control the visual output of a color display device 102 yields a color scheme. It will be understood that these various forms of information are merely illustrative and that color vision deficiency information taking other forms may be utilized by the color display system 100. Various implementations of embodiments will be discussed in a context of one or more of such forms of information, and it will be further understood that such forms of information may be interconverted and substituted one for another. These various forms of color vision deficiency information may be input to and output from the color display system 100 in a variety of ways as will be described further below.

The user interface 104 may be arranged to receive user instructions for the operation of the color display system 100 and for the entry of information by the user into the color display system 100. In one example of an implementation, the user interface 104 may receive color vision deficiency information from the user indicating the user's ability to distinguish colors. The color scheme for the color display device 102 may then be adjusted in adaptation to the color vision deficiency information so that all colors displayed by the color display device 102 may be distinguished by the user. In another example of an implementation, the user interface 104 may receive color vision deficiency information that is not provided by the user. As examples, such color vision deficiency information may be locally or remotely stored and retrieved.

The user interface 104 may be integrated with the color display device 102 including a touch sensitive display allowing the user to select options simply by touching a particular area on the color display device 102. Alternatively or in addition, switches, buttons, dials or similar input devices may be arranged around the color display device 102 to allow the user to make the necessary selection of color vision deficiency information. The user inputs may also be made from controls arranged around or built into the steering wheel or other controls of a vehicle. The color display system 100 may be provided with a remote control that includes the user interface 104.

The controller 106 may be arranged to receive information from the user interface 104 and to control a parameter of a color scheme of the visual information displayed on the color display device 102 in response to the user's ability to distinguish colors. As an example, the controller 106 may be configured to receive an input from the user indicating any color vision deficiencies the user may have and to control the color scheme display characteristics of the color display device 102 in response to the user input. In an implementation example, the controller 106 may automatically adjust at least one parameter of a color scheme for the color display device 102 in response to information from the user indicating a color vision deficiency of the user. The parameters of a color scheme for the color display device 102 that may be controlled include as examples, but are not limited to: a combination of reds, greens and blues; the use of monochrome, e.g., black and white; or the intensities of the respective colors. The parameters of a color scheme for the color display device 102 may also be controlled so that particular colors that may not be distinguished by a user with a given color vision deficiency do not appear adjacent to each other on the color display. As examples, a user's color vision deficiency may be a bi-chromatic color vision deficiency, a complete color vision deficiency, or no color vision deficiency. As an example, the user may be completely color blind, in which case the controller 106 may control a color scheme for the color display device 102 to display in monochrome only. Grey scales may then be utilized in a monochrome color scheme to display the information instead of colors. Alternatively, if the user's input indicates a red/green bi-chromatic color vision deficiency, then the color scheme may be adjusted so that red and green are not both utilized on the color display device 102 or are separated from each other in the displayed information by at least one other color.

In an alternative implementation, the controller 106 may be arranged to receive information from the user interface 104 in the form of specific adjustments to be made in the red, green and/or blue parameters of a color scheme for the visual information displayed on the color display device 102. In an example of another implementation, the controller 106 may be arranged to receive information from the user interface 104 and to control color intensity parameters of a color scheme for the visual information displayed on the color display device 102. In an alternative implementation, the controller 106 may be arranged to receive information from the user interface 104 and to control monochrome parameters of a color scheme for the visual information displayed on the color display device 102. The controller 106 may be configured to adjust the color scheme utilized by the color display device 102 to display information in response to the user input, and in response to stored relationships between color vision deficiencies and corresponding color schemes including acceptable color combinations for a given deficiency.

In general, the color display system 100 may be utilized together with a color display device 102 for a navigation system. In one example of an implementation, the color display system 100 may be applied to a color display device 102 for a navigation system in a vehicle. As examples, the vehicle may be an automobile, a truck, a bus, or construction equipment. In another implementation example, the color display system 100 may be employed with a color display device 102 in another type of transportation apparatus, such as an aircraft, a locomotive, a subway, a submarine, or a ship.

As illustrated in FIG. 1, in one example of an implementation, the color display system 100 may further include a data device 108. The data device 108 may store a user's color vision deficiency information, such as a user's detailed color vision profile, or a user's corresponding color scheme for a color display device 102. The color display system 100 may be configured to retrieve a user's color vision deficiency information from the data device 108, and to control a parameter of a color scheme for the color display device 102. The retrieval may, as an example, be in response to a further input at the user interface 104 indicating an identity of the user. The data device 108 may also store a color scheme to be utilized by the color display device 102, corresponding to a color vision profile including needed color adjustments correcting for a color vision deficiency of the user. In another example of an implementation, the data device 108 may retrieve a user's color vision deficiency information from a local or remote source. As an example, the data device 108 may communicate with and retrieve such information from a remote server.

In an implementation example, the data device 108 may be arranged to store data on a data medium 110. In another embodiment of an implementation, the data medium 110 may additionally forward the data elsewhere for storage, distribution, and retrieval. As an example, the user data may be forwarded to a remote server.

When a user activates the color display system 100, the user may retrieve his/her own color vision deficiency information as previously stored. Any suitable user identifier may be utilized to facilitate such storage and retrieval. As an example, a personal identification number (PIN) may be entered into the color display system 100 to retrieve the information. When the user returns to a vehicle, he may simply enter his identification data and the color display system 100 may automatically restore a color scheme corresponding to his color vision deficiency information. Alternatively, the color vision deficiency information may be stored on a SIM card itself and uploaded into the color display system 100. Inserting the SIM card from a mobile phone into a vehicle's color display system 100 may also provide the system with an indication of the identity of the user and allow the color display system 100 to retrieve the color vision deficiency information for that given user. Alternatively, the user may be identified by some other means. As another example, an external device such as a mobile telephone or a portable digital assistant (“PDA”) may send information to and/or receive information from the color display system 100. The external device may communicate with the user interface 104 by a wired or wireless connection. As examples, such a connection may be a parallel, serial, USB, or fire wire connection, or a wireless link.

If the user has not utilized the particular color display system 100 before, he may input a preferred color vision profile or color scheme according to any corresponding color vision deficiency he might have. As an example, the user may select from a menu of known color vision deficiencies, mapped to corresponding color vision profiles or color schemes for the color display device 102. In this way the color display device 102 may be optimized for any user and his color vision profile may be saved for future use. The color vision profile selected by the user may make viewing the color display device 102 more comfortable and safer for the user.

In an example of an implementation, the color display system 100 may provide a visual display for a vehicle navigation system. As an example, the color display system 100 may be utilized for automatically controlling at least one parameter of a color scheme for a color display device 102 for use as a visual display in such a vehicle navigation system. The color display device 102 may provide navigational information to the user in the form of a color map that displays the current location of the vehicle in the local area. The user interface 104 may include control inputs for the user to interface with the color display system 100. As an example, such control inputs may be utilized to select the destination of a journey or to adjust parameters of a color scheme for the color display system 100. Such a navigation system may also provide information about the status of other systems within the vehicle such as engine temperature, fuel level, oil level, etc. In addition, the color display system 100 may also act as an in-vehicle entertainment system for the driver and passengers and may include a television, video/DVD player, radio display or other entertainment that may be viewed on the color display device 102.

Typical information displayed by a vehicle navigation system may include a map, normally in color, showing the vehicle's current location. An arrow may indicate the current direction of the position of the vehicle relative to the map. Different road types may be displayed in different colors. As an example of a configuration for a user having no color vision deficiency, blue may be utilized for divided highways, green for major two-way roads, and brown for smaller roads. The route that the navigation system has calculated to a destination may, as an example, be displayed in red with an arrow to indicate the current location and direction of the vehicle. Other information such as the map scale and the cumulative distance traveled during a vehicle trip may also be displayed on the device in other colors. When the user has a color vision deficiency, the colors utilized on the color display device 102 shown in FIG. 1 may accordingly be adjusted by the color display system 100. As an example, reds and greens may be removed and replaced with different colors, thereby allowing a user with a red/green color vision deficiency to view the information on color display device 102 normally and to interpret the information accurately.

In one embodiment of an implementation, the color display system 100 may allow the user, upon activating the color display system 100, to select a user color vision deficiency type or profile from a list. As an example, the user may be prompted to indicate their color vision deficiency from among settings including but not limited to normal, bichromatic, and color-blind vision. Under a normal setting, normal display colors defined without consideration of color vision deficiencies may be utilized. Under a bi-chromatic setting, display colors may be adapted to a color scheme suitable for a vision deficiency in two colors, e.g. a red/green deficiency. With a complete color blindness setting, the color display device 102 may be switched to a monochrome color scheme. The monochrome color scheme may be in a grey scale or in shades of another selected color. In an example for implementing normal, bichromatic, and color-blind settings, the color scheme of the color display device 102 may be adjusted by the color display system 100 according to standardized settings, which are accessible by the controller 106, and that are known to be satisfactory for users with a particular color vision deficiency. If the user is completely color blind, as an example, then dashed lines may be used in addition to grey scales to distinguish between roads or other geographic features.

The color display system 100 to be convenient for use by both visually impaired users as well as those with normal color vision. The color display system 100 therefore may offer the user a color correction option to correct the color scheme of the color display device 102 for color vision deficient users. Not selecting this option leaves the color display device 102 in a normal mode of color scheme operation with no adjustment of color combinations or display parameters. Selecting this color correction option further may allow the user to input his specific color vision deficiency. Users who know they have a certain type of color vision deficiency may select their deficiency type. Users who know their color vision profile or color scheme may select it. As an example, a red/green color vision deficiency may be selected and the controller 106 may adjust the color scheme utilized by the color display device 102 to colors that are known to be distinguishable for users with this deficiency.

If the user does not know whether or not they have a color vision deficiency, or if they notice that they cannot easily distinguish different colors on the screen of the color display device 102, then the user's color vision may be tested. In one example of an implementation, a user may utilize the user interface 104 to provide a diagnosis of the ability of the user to distinguish colors. As an example, a series of color vision test images may be displayed on the color display device 102. The user may be presented with queries based on the images displayed. Such a diagnosis may be performed by displaying test images to the user in sequence or, alternatively, the user may be provided with a number of images on one screen and then be prompted to select a particular one of the images. Alternatively, the diagnosis may be performed by displaying a series of images and then prompting the user to select one of the images from the series as being the most distinguishable.

In one example of an implementation, an automated diagnosis may be performed to establish any color vision deficiency of the user. The diagnosis of the user may take place on the color display device 102 of the color display system 100. Any suitable test may be utilized to determine a color vision deficiency of the user. As an example, the Ishihara or Velhagen pseudoisochromatic tests may be utilized to diagnose color vision deficiencies. As an example, test plates such as pseudoisochromatic plates including arrangements of colored dots made up of colors that may be indistinguishable to people with particular color vision deficiencies, may be shown to the user on the color display device 102.

The test plates may be designed so that a particular number or image is visible to a test user with normal color vision. A person without a color vision deficiency may, as an example, see the number “12” in a colored representation on a test plate. To a user with a color vision deficiency, no number may be visible or, an alternative number may be visible. In this diagnostic mode of the color display system 100, a series of such test plates may be displayed in sequence on the color display device 102 and the user may be prompted to indicate whether or not they can see a particular number. After each test plate is displayed, the user may be presented with a multiple choice menu screen that allows the user to select a number seen within the test plate. The color display system 100 may register all of the answers that the user has given and provide a diagnosis of any color vision deficiency of the user on the basis of the test answers. The diagnosis may be based on a look-up table accessible by the color display system 100 of test answer combinations that correspond to certain color vision deficiencies. Alternatively, an algorithm may be utilized by the controller 106 to determine any color vision deficiency of the user from the results.

If a color vision deficiency is established, then the controller 106 may analyze the color vision deficiency with respect to the colors that would be displayed to users with normal color vision. The controller 106 may then automatically adjust the parameters of a color scheme for the color display device 102 to remove color combinations that the user cannot distinguish between. In addition, the controller 106 may identify portions of the information on the color display device 102 where colors that the user cannot distinguish are close to or next to each other. The displayed colors may then be adjusted so that colors that the user cannot distinguish do not appear next to each other on the color display device 102. If it is not possible to display the information using colors that the user can differentiate between, then the information may be displayed in monochrome. If no color vision deficiency is diagnosed from the test, then normal colors may be utilized on the color display device 102.

Once a user diagnosis is completed, the user's color vision deficiency information, if any, may then be stored for future use. Such information may, as an example, include a color vision profile for the user, constituted by details as to those colors or combinations of colors between which the user can distinguish. As a further example, the user's color vision deficiency type or color vision profile may be converted into an acceptable color scheme for the user, limiting colors displayed by a color display device 102 to combinations compatible with the user's color vision deficiency.

FIG. 2 shows a flow chart 200 of an example of an implementation of a process 200 for automatically controlling at least one parameter of a color scheme for a color display device 102. The process starts at step 202, and then a user provides an input at step 204 through a user interface 104 to a controller 106 indicating the user's ability to distinguish colors. The input at step 204 may be a one-way information input or may be the result of a two-way interactive process. The input may take the form of, as examples, the user's color vision profile, the user's type of color vision deficiency, the user's color scheme, or color vision deficiency test data for analysis by the color display system 100. At step 206, the controller 106 outputs a color scheme for visual information displayed on the color display device 102 in response to the user's ability to distinguish colors. The process ends at step 208.

The output at step 206 from the controller 106 controls the color scheme utilized by the color display device 102. If a user's color vision deficiency status is normal, then the controller 106 outputs data to be displayed on the color display device 102 utilizing a normal color scheme. If, alternatively, a user's color vision deficiency status indicates a bichromatic color vision deficiency, then parameters of a color scheme for the data output by the controller 106 to be displayed on the color display device 102 are adjusted to take the bichromatic deficiency into account. As an example, if a user is affected by a green-red bichromatic vision deficiency, then parameters of a color scheme for the data output are adjusted so that the subject green and red colors are not both used, or are not displayed adjacent to each other, or otherwise so that colors that can be distinguished from each other by the user are utilized. As a further example, if a user's color vision deficiency status is completely color-blind, then a monochromatic color scheme is selected by the controller 106 for the output data to be displayed on the color display device 102.

In summary, the color display system 100 for a navigation system includes a color display device 102, a user interface 104, and a controller 106. The color display system 100 may be utilized, as an example, as a display device for an in-vehicle navigation system. The color display system 100 permits the color scheme of the color display device 102 to be adjusted to take into account the user's ability to distinguish colors. The color display device 102 may thereby compensate for any color vision deficiencies that the user may have. The color vision deficiency type, color vision profile, or color scheme for the user may then be stored and recalled for future use.

Although the color display system 100 has been described in a context of utilization as a visual display for a vehicle navigation system, end uses with other navigation systems are contemplated. As an example, the color display system 100 may be utilized as a color display device 102 for a navigation system in an aircraft, locomotive, subway, submarine, or ship.

Persons skilled in the art will understand and appreciate, that one or more processes, sub-processes, or process steps described in connection with FIGS. 1 and 2 may be performed by hardware and/or software. Additionally, the color display system 100 may be implemented completely in software that would be executed within a processor or plurality of processors in a networked environment. Examples of a processor include but are not limited to a microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

Although the invention has been described with reference to a particular example of an embodiment, it will be apparent to those skilled in the art that various changes and modifications can be made without departing from the scope of the invention. Such changes and modification are intended to be covered by the appended claims.

What is claimed is:

1. An apparatus for automatically controlling at least one parameter of a color scheme for a color display device for use in a navigation system comprising;
a color display device arranged to display visual information to a user;
a user interface arranged to receive color vision deficiency information indicating the user's ability to distinguish colors; and
a controller arranged to receive the information and to control a parameter of a color scheme of the visual information displayed on the color display device in response to the user's ability to distinguish colors.
